(19) United States
(12) Patent Application Publication
(10) Pub. No.: US 2012/0027901 A1
(43) Pub. Date: Feb. 2, 2012

(54) Infusion System for a Liquid Food Product and Method for Directly Heating a Liquid Food Product in an Infusion System

(75) Inventors: Henrik Kjerbye, AL Bida (KW); Gottfried Kowalik, Gescher (DE); Ludger Tacke, Velen (DE); Uwe Schwenzow, Ahaus (DE); Reinhold Dreckmann, Duelmen (DE)

(73) Assignee: GEA TDS GMBH, Sarstedt (DE)

(21) Appl. No.: 13/146,586

(22) PCT Filed: Jan. 11, 2010
(86) PCT No.: PCT/EP2010/000080

§ 371 Date: Aug. 23, 2011

(30) Foreign Application Priority Data
Jan. 27, 2009 (DE) 10 2009 006 248.3

(51) Int. Cl. A23C 3/037; A01J 11/00

(52) U.S. Cl. 426/474; 99/452

(57) ABSTRACT

Infusion system for a liquid food product to be heated, including an infusion chamber limited by an infusion tank with a downward tapering bottom, said infusion chamber having a product inlet and a product outlet, said infusion system having a steam inlet, wherein
the steam inlet is designed in the form of two steam inlets separated from each other spatially and fluidically;
the first steam inlet is connected for passing fluid to a second channel,
the product inlet is connected for passing fluid to a first channel which encompasses the second channel in a ring shape and also opens into an infusion chamber,
   and the second steam inlet is connected for passing fluid to a plurality of inlet openings disposed in a ring shape and radially encompassing the first channel on the exterior and also opening into the infusion chamber in the upper area and from above.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to an infusion system for a liquid food product to be heated, in particular a dairy product such as milk, cream or yogurt, which includes an infusion chamber limited by an infusion tank with a downward tapering bottom, said infusion chamber having a product inlet for the food product to be heated in its upper area and a product outlet for the heated food product in its lower area, said infusion system having a steam inlet for the steam heating medium in the upper area. Furthermore, the present invention relates to a method for directly heating a liquid food product to be heated of the aforementioned kind in an infusion system of the previously described principal construction by means of a steam heating medium, as well as the utilisation of the previously mentioned infusion system in a process plant for the production of, amongst others, an UHT-milk (ultrahigh heated milk) or ESL-milk (extended shelf life milk).

Heat treatment of food products for extending the shelf life is a well-known and frequently used method. The food products may be dairy products like milk, cream or yogurt, e.g. The heat treatment using the steam heating medium (normally water steam in an overheated condition) can be performed with quite different methods, either directly or indirectly ([1], Heinz-Gerhard KESSLER, Lebensmittel-Verfahrenstechnik, Schwerpunkt Molkereitechnologie, first edition, München—Weihenstephan, editor A. Kessler, 1976, p. 154 to 159). An indirect method is for instance heating using different executions of heat exchangers (tubular heat exchanger, plate heat exchanger). The direct methods comprise two main groups, namely the injection method using steam ([1], p. 154, 155) and the infusion method using steam ([1], p. 156).

Through the direct heat exchange between the steam and the liquid food product, the latter is heated directly, rapidly and efficiently. Thanks to this rapid method, the treatment time can be shortened, resulting altogether in a reduced heat effect onto the food product, by which a food product is obtained which retains a higher level of quality with respect to smack in the first instance. The rapid and gentle heat treatment in the direct heating method is achieved in a bargain against a higher energy consumption compared to the indirect heating treatment. Therefore, one tends to further improve the heat transfer conditions in the direct method discussed here, which will inevitably result in a smaller necessary temperature difference between the steam as a heat carrier and the food product to be heated, and thus further favours the gentle treatment of the latter.

In the injection method, the food product to be heated is conveyed through an injector. The steam is directly injected into the food product for the sake of heating, and the heat exchange is completed in a so-called mixing room (DE 10 2007 017 704 A1).

In the infusion method, wherein the infusion heating is applied, the finely divided food product is heated in a steam chamber. The system pressure of steam and product are almost identical in this method. Through this, the temperature difference between the heating medium and the food product is significantly lower than in the injection method, resulting in a gentler product treatment. The disadvantages of the infusion method compared to the injection method are a more complicated process technology and higher investment cost. An overview about process concepts for sterilizing food products, in particular taking into account direct heating methods of the afore described kind, are given by Saskia SCHWERMANN, Uwe SCHWENZOW in “Verfahrenskonzepte zur Herstellung von ESL-Milch”, Beitrag in drei Abschnitten (contribution in three portions) in Deutsche Milchwirtschaft, 11/2008 to 13/2008 (59. Jg.). However, in view of the infusion principle, only one infusion tank is mentioned in FIG. 4 of this publication, in which steam and the food product to be heated are supplied in the upper area of the tank, and the heated food product is discharged at the lower end of the conical bottom of the tank.

The document DK 169 248 B1 discloses a plant for sterilizing milk. Such a plant is known as a direct-UHT-plant (direct ultra high temperature plant). In these plants, the milk which is supplied to a so-called infusion chamber, is introduced into a steam atmosphere in such a way that the milk is heated to a temperature of about 140° Celsius. In view of its generic features, the aforementioned infusion chamber corresponds to an infusion chamber of the generic infusion system, like that of the subject matter of the present invention.

Essential characteristics of the aforementioned known infusion chamber are that the milk to be heated is supplied to an infusion tank, limiting the infusion chamber and provided with a conical bottom, in the central head area via a plurality of openings. Furthermore, the milk divided into fine droplets in this manner is intended to fall freely in an atmosphere of pressurized steam (so-called downward flow) without touching any surface on its way to the discharge in the conical bottom as far as possible, this being the wishful concept. The steam is supplied in the head area of the tank via a housing surface perforated by a plurality of openings, i.e. the steam approaches the central product stream from the outside when seen in the radial direction.

Further infusion tanks for the applications discussed here have become known in the state of the art, all of them working according to basic principle shortly outlined above, wherein the splitting, distribution and supply of the product to be heated in the head area of the tank on the one hand, and the supply of the steam also in the head area of the tank on the other hand are differently realised in design. The infusion tanks according to EP 0 650 332 B1 and EP 1 536 702 B1 will be shortly delineated in the following, substitutional for the construction prevailing in the infusion method.

In EP 0 650 332 B1, a downward flow heating apparatus is described wherein the liquid to be heated is supplied to a pressure chamber centrally from the upside via a liquid supply channel extending somewhat into the same, and is discharged in the form of liquid streams via a supply plate provided with a number of plate channels. The steam is laterally charged into the head room of the pressure chamber above the discharge point for the liquid, and supplied to the pressure chamber continuing below from top to bottom concentrically around this discharge point via a steam distribution plate that is provided with a plurality of openings.

From EP 1 536 702 B1, an apparatus for an infusion device for a liquid food product is known, which includes a pressure tank having a conical bottom with an inlet for the food product in its upper area, and an outlet for the food product in its lower area. In this, the product inlet is provided such that the food product entering the central head area of the pressure tank is split into fine droplets, and falls down through the tank freely as a downward flow. The infusion device further includes an inlet for steam, which is provided such that steam enters the upper area of the pressure tank through a distribution chamber concentrically encompassing the tank surface. The distribution chamber is defined by the tank wall, a guiding plate and at least one perforated plate in such a manner that the steam entrance into the pressure tank takes place somewhat below the product inlet, namely such that it is directed towards the downside as a ring-shaped flow, touching the tank wall, and having a speed of<2 m/s.

In the operation of the infusion tanks described above, it has come out that the food product to be heated has always a more or less great affinity towards the steam. As the steam encompasses and impinges on the central stream of product from the exterior, the latter has in principle the tendency to expand radially towards the exterior. Through this, it is difficult to guide the stream of product centrically up to the conical bottom part, without that cylindrical wall areas in the middle and lower part of the tank are touched or be tangent to it. A contact of the wall areas by the food product can lead to unwanted deposits and scalding. In case that the food product to be heated contains fibrous contents or pieces, according to circumstances the contact of a respective food product with the walls of the tank results in undesired precipitation of these components. In order to counter-act deposits, scalding or precipitations, the cylindrical lower area of the infusion tank is already cooled in most cases.

It is the aim of the present invention to achieve central guiding and bundling of the stream of food product generated in the infusion chamber in an infusion system of the generic type, to reduce the risk of deposits and scalding of food product on the walls of the infusion tank and the tendency to precipitate solid components of the food product to be heated, such as fibres or pieces, and to ensure easy adaptability to different food products and desired operating conditions, such as flow rate, heating duration, maximum heating temperature and the like. Furthermore, it is the objective of the present invention to designate a method for directly heating a liquid food product in an infusion system.

### BRIEF SUMMARY OF THE INVENTION

In contrast to known solutions which have been outlined shortly above, the first inventive basic idea is to supply the steam via two steam inlets spatially and fluidically separated from each other, and to bring the two steam flows generated through this from two sides to the finely divided food product, which permeates an infusion chamber as a downward flow. The two separate steam flows, a first steam and a second steam, can be separately controlled with respect to their quantity. The respective associated heat input into the food product can also be controlled through this via the controllable quantitative proportion of the two steam flows.

The second inventive basic idea, again in contrast to known solutions, is to introduce the heating medium first steam centrally, preferably concentrically, into the upper area of the infusion tank, and to let this first steam propagate itself in the form of a free stream directed from top to bottom. According to the invention, the first steam is supplied, via a first steam inlet, to a second channel which disembogues in the centre of the upper area into the infusion chamber limited by the infusion tank, preferably concentrically and in the direction of the longitudinal axis thereof. According to the fluidic principles, the above-mentioned free steam stream propagates itself in a straight line and there will be a mixing with its surroundings ([2], Bruno ECK, Technische Strömungslehre, 7. edition, Berlin/Heidelberg/New York, Springer-Verlag, 1966, p. 151 to 155).

The third inventive basic idea, also in contrast to known solutions, is according to the present invention to guide the food product to be heated via the product inlet to a first channel, which encompasses the second channel (3.3d) in a ring shape, preferably concentrically, and also disembogues into the infusion chamber in the upper area and from above.

According to the fluidic principles, the mixing of the central free steam stream with its surroundings takes place such that the finely divided particles of the food product are dragged along from the exterior to the interior (see [2], p. 151 to 155), and the ring-shaped flow of the food product remains essentially centrally bundled through this, and therefore it does not touch the wall of the infusion tank in the spirit of the aim of the invention.

The fourth inventive basic idea is that in addition, the second steam is made to impinge on the ring-shaped stream of the food product from the exterior when seen in the radial direction, preferably concentrically. According to the invention, this impingement on the product particles, per se known when seen in an isolated view, takes place in that via a second steam inlet, the second steam is supplied to a plurality of entrance openings which are arranged in ring form and encompass the first channel, and thus the ring-shaped flow of the food product, radially from the exterior, and also open into the infusion chamber in the upper area and from above. The second steam supplied from the exterior ensures in a high degree that food product possibly drifting radially off in the outward direction is kept away from the wall of the infusion chamber, first of all in the middle and lower area, and does not scald there.

In the standard case, the heat input from the interior by the first steam into the stream of food product is predominant, wherein also the proportion between inside and outside of the heat inputs into the above-mentioned stream is controllable in a wide range via the controllable quantitative proportion between the first and the second steam. It has come out that the infusion system of the present invention can realise a proportion between inside and outside of the heat inputs of 80:20 to 50:50 (always in percent). As has come out, the choice of the optimum proportion is product-dependent and it is determined empirically, the proportion being very simply controllable via the respective pressure of the first and second steam, or via the pressure difference between the pressure of the first and the second steam.

A particularly efficient introduction of the second steam via the entrance openings, and through this a particularly purposeful impingement on the food product to be heated, is achieved when the inlet openings are designed in the form of a first collar of inlet openings and of a second collar of inlet openings, and when the first collar of inlet openings radially encompasses the second collar of inlet openings on the exterior, preferably concentrically.

According to a further proposal, best results in view of the prevention of impingement of the food product on the wall of the infusion tank are achieved in that the first and the second collar of inlet openings open out directly into the wall area of an upper tank opening that is preferably concentric to the longitudinal axis and through which the upper area opens in the upward direction towards the first channel and the second channel.

A particularly favourable penetration of the second steam into the food product to be heated is achieved in that the first collar of inlet openings is oriented parallel to the longitudinal axis of the upper tank opening, and the second collar of inlet openings is oriented downward and slanted towards this longitudinal axis.

It has proven to be advantageous, as is also proposed, when the first channel supplying the food product has a first point of confluence in the upper area, the second channel supplying the steam has a second point of confluence in the upper area, and the inlet openings have a third point of confluence, when the second and the third point of confluence are disposed approximately on the same height, and when the first point of confluence is provided above the second point of confluence.

Easy adaptability of the infusion system to desired operating conditions, like flow rate, heating duration, maximum heating temperature and the like is ensured in that, as a further proposal provides, the first channel has a variable passage cross section at its first, droplets or film flow forming point of confluence in the upper area, wherein the same can be changed continuously or in steps in a respective preferred embodiment.

A particularly advantageous embodiment permits in a relatively simple way the formation of an annular gap shaped cross section that is continuously changeable in its passage cross section for generating a ring-shaped, in itself closed film flow of the food product to be discharged into the infusion chamber and to be heated. This is achieved in that the passage cross section has the form of an annular gap shaped cross section which is formed between a bore in a head companion flange limiting the upper area of the infusion chamber, and a preferably conical lower body portion penetrating the bore, wherein the former grips into the upper area, radially tapers thereto at the exterior and forms an end side portion of an inner housing body, which is axially movable from the exterior of the infusion tank in the longitudinal axis thereof. According to a preferred embodiment, particularly favourable flow conditions are generated in the annular gap cross section in that the bore is designed as a convergent nozzle, wherein this nozzle-shaped bore is preferably arranged in a separate nozzle plate, which is received in the head companion flange by positive and non-positive fit.

The arrangement is simplified when the inner housing body, limiting the first channel at the interior on its surface side periphery, receives the second channel radially at the interior, which second channel has a connection to the circumferential surroundings of the inner housing body via plural admission openings arranged such as to be distributed over the circumference of the inner housing body.

Favourable flow conditions for the stream of the first steam leaving the second channel, and a small delivery resistance and thereby a small delivery loss result in that the second channel (3.3d) widens out like a diffuser at its outlet location in the lower body portion (3.3c), and that the diffuser-like inner contour and a downward tapering surface area of the lower body portion (3.3c) form a bezel-like circumferential edge (3.3e) at their ends.

The present invention furthermore proposes an infusion head, to which the food product to be heated and the steam heating medium are supplied and which distributes these fluids into the first respectively second channel and the inlet openings and discharges them from there into the upper area of the infusion tank, and by which the passage cross section of the first channel can be continuously changed in the area of its annular gap cross section at the exit side. This is achieved in that an infusion head arranged on the head companion flange at the upper side is provided, which consists of a product housing neighbouring to the head companion flange and of a steam housing following up the former. The product housing and the steam housing are sealingly penetrated by the inner housing body, preferably concentrically, which is movable in the direction of the longitudinal axis. A middle and the lower body portion of the inner housing body form, together with the product housing, a ring-shaped product chamber having the product inlet, and the middle and an upper body portion as well as an adjustment bar of the inner housing body, following up the latter, form with the steam housing a ring-shaped steam chamber having the first steam inlet.

Furthermore, in the context of a second embodiment of the infusion tank, the invention proposes a capturing device which brings the heated food product together into the centre of the lower area of the infusion chamber, and leads it downward from there into the surroundings under favourable flow-out conditions. For this purpose, this capturing device is provided in the lower area, it consists at least of a capturing funnel, whose conically downward tapering intake surface opens out into a downward opened flume. The flume is in alignment with an outlet channel arranged in an outlet pipe, wherein the outlet pipe follows up the bottom at its upper end, and verges into the product outlet at its lower end.

In order to prevent deposits and scalding of the heated food product or at least to minimize them, an advantageous embodiment of the infusion system according to the present invention proposes that at least the bottom of the infusion tank is designed double-walled and a coolant room charged with coolant is provided between the two walls. It has furthermore proved as advantageous in many cases of utilisation when the lower portion of the middle area (2a) is designed double-walled in addition, and when the coolant room (2h) continues between the two walls.

In a preferred embodiment, the coolant room extends also over the circumference and the entire axial length of the outlet pipe up to the product outlet.

The present invention furthermore proposes a method for directly heating a liquid food product, a dairy product like milk, cream or yogurt in particular, in an infusion system. The latter comprises, amongst others, an infusion chamber in a per se known manner, to which the food product to be heated is supplied in the upper area, and from which the heated food product is discharged in the lower area. The food product to be heated entering finely divided the infusion chamber permeates the infusion chamber as a downward flow. Steam heating medium is supplied to the upper area, wherein the food product to be heated in the infusion chamber is in a heat exchange with the steam during the entire residence time therein.

The basic process technology concept essential for the present invention is that a first steam is supplied to the upper area centrally from top to bottom as an inner free stream, and that the food product to be heated is supplied to the upper area from top to bottom as a ring-shaped middle free stream encompassing the inner free stream of the first steam, preferably concentrically, and that a second steam is supplied to the upper area from top to bottom as a ring-shaped outer free stream which encompasses the middle free stream, preferably concentrically. The fluidic effects of these materials processing measures, which differ significantly from the anterior procedures in the state of the art, have already been described above, in the context of the infusion system of the present invention.

It has proven to lead particularly well to target, as is also provided, when the first channel forms the food product to be heated in fine droplets or as a film flow when it enters the upper area. It is decisive that the droplet- or film flow forming cross sections are disposed concentrically around the location of the input of the first steam into the infusion chamber.

The impingement of the first steam, centrally supplied to it from the interior, and of the second steam, supplied in ring form at the exterior, onto the annularly discharged food product to be heated, establishes the possibility of a very advantageous control of the heat input into the food product to be heated on the one hand. The control takes place in a surprisingly simple manner by changing the quantitative proportion between the first and the second steam. On the other hand, it has come out in a not predictable manner that the bundling of the discharged stream of the food product to be heated and its focussing in the centre of the infusion tank are achieved by the above-mentioned control of the quantitative proportion.

According to a particular embodiment of the present invention, the infusion is preferably used in a process plant for the production of UHT milk (ultra high temperature milk) or ESL milk (extended shelf life milk) in the course of milk heating, with the proviso that the milk to be heated is withdrawn form the process plant and that the heated milk is further processed in the process plant.

Moreover, the infusion system is advantageously used in process plants for the production of a dairy product, and here for the production of cream or yogurt in particular.

### BRIEF DESCRIPTION OF THE SEVERAL VIEWS OF THE DRAWINGS

A more profound representation will result from the following description and the attached figures of the drawing and from the claims. Whilst the invention is realised in very different embodiments, a realisation example of a preferred embodiment of the proposed infusion system is shown in the drawing and described with respect to design and function below.

FIG. 1 shows a centre cut through a preferred first embodiment of an infusion system of the present invention with an infusion tank and an infusion head on the head end of the infusion tank as the essential components;

FIG. 1a shows a centre cut through a second embodiment of an infusion system of the present invention with an infusion tank, a not shown infusion head according to FIG. 1 on the head end and with a capturing device on the foot end of the infusion tank as the essential components;

FIG. 2 shows in a magnified representation the centre cut through the infusion system according to FIG. 1 in the area of the head end of the infusion tank and comprising the infusion head;

FIG. 3 shows in a magnified representation the centre cut through the infusion system according to FIG. 1a in the lower area and comprising the capturing device, and

FIG. 3a shows the centre cut through the infusion system according to FIG. 3 in a perspective representation.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

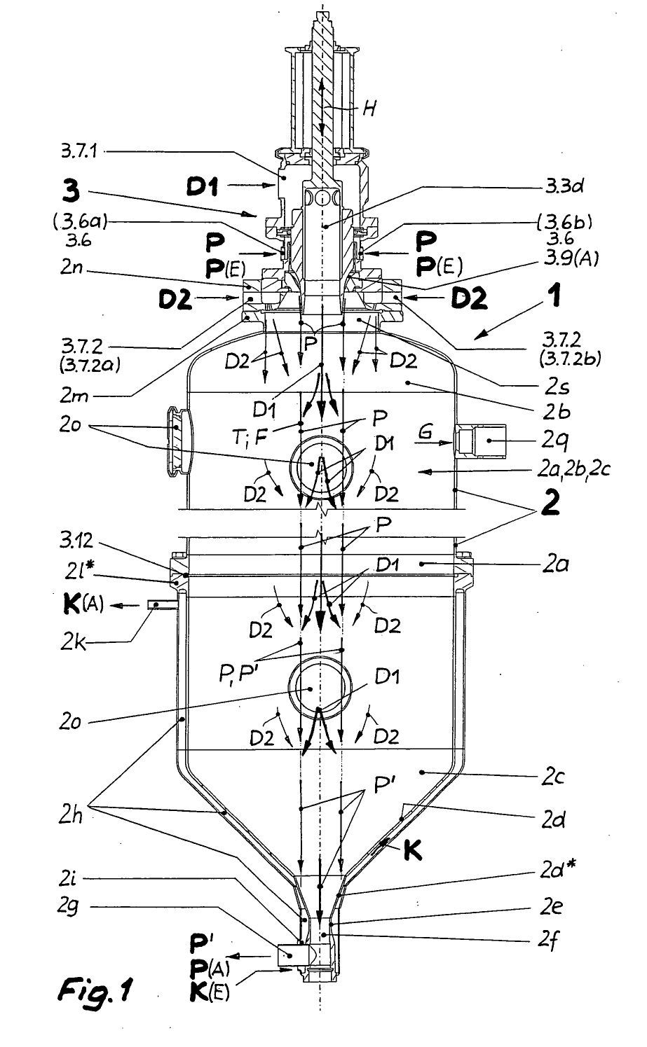

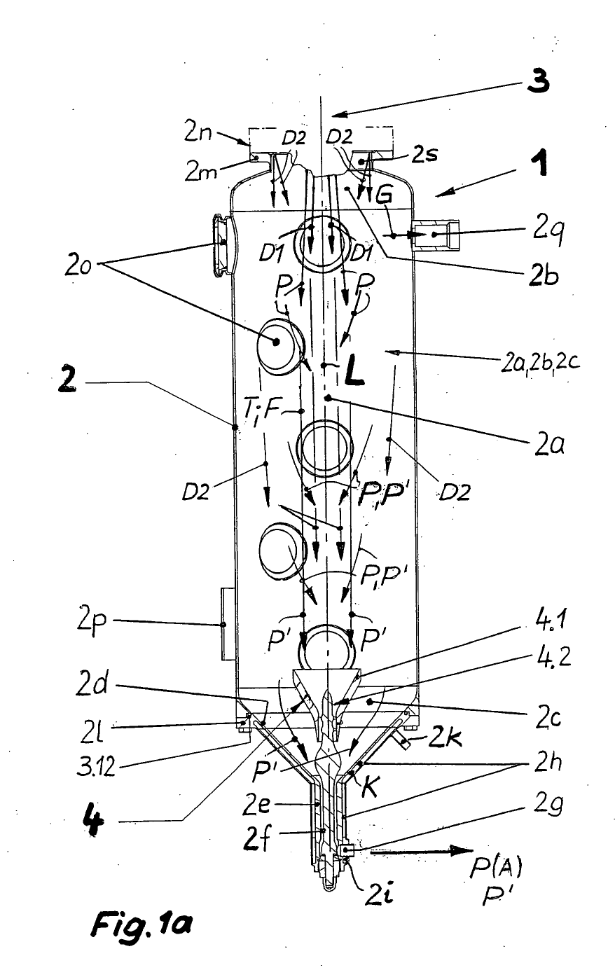

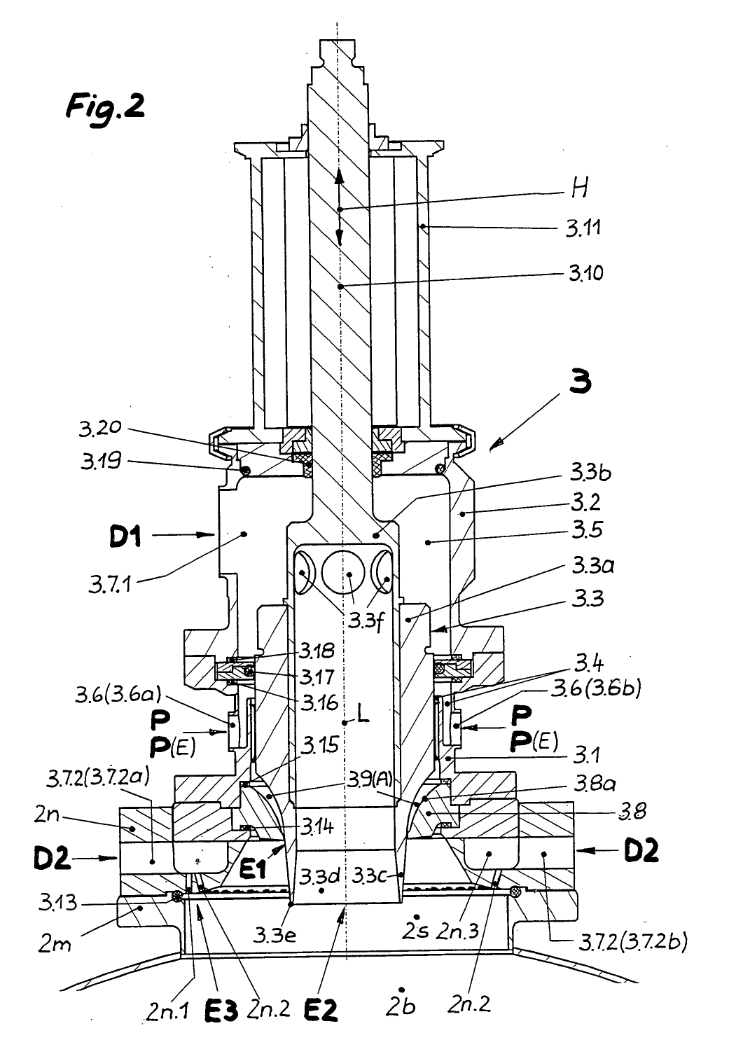

An infusion system 1 (FIGS. 1 to 3a) for a food product to be heated P includes an infusion tank 2 with a downward tapering and preferably conical bottom 2d and an infusion head 3 on the head end. The infusion tank 2 limits an infusion chamber 2a, 2b, 2c with a product inlet 3.6 for the food product to be heated P in its upper area 2b, and with a product outlet 2g for the heated food product P′, which leaves the same as a leaving product flow P(A) in its lower area 2c. In a preferred embodiment shown in FIGS. 1 and 2, the product inlet 3.6 for an entering product flow P(E) is designed in the form of first product inlet neck 3.6a and a second product inlet neck 3.6b, which disembogue into a ring-shaped product chamber 3.4, and which are preferably located diametrically opposite to each other.

Furthermore, above its upper area 2b, the infusion chamber 2a, 2b, 2c has a first steam inlet 3.7.1 for a heating medium first steam D1, preferably water steam in the condition of hot steam, and a second steam inlet 3,7.2 for a similar heating medium second steam D2. Both steam inlets 3.7.1 and 3.7.2 are designed as separate from each other spatially and fluidically, and the respective flow paths leading away from them disembogue into the upper area 2b at different locations in respect of the food product to be heated P which will still be described below. In a preferred embodiment shown in FIG. 1, the second steam inlet 3.7.2 is designed in the form of a first steam inlet neck 3.7.2a and a second steam inlet neck 3.7.2b, which open into a preferably ring-shaped steam distribution chamber 2n.3, and which are preferably located diametrically opposite to each other.

The lower end of the conical bottom 2d disembogues into a conical flowing-out hole 2d*, and the same is followed up by an outlet pipe 2e accommodating an outlet channel 2f, which outlet pipe branches off into the crosswise running product outlet 2g above its lower end. The lower end of the outlet pipe 2e is closed by a not shown and designated stopper. The conical bottom 2d and also the lower portion of a middle area 2a of the infusion tank 2 that follows at the upper side are designed double-walled, and between the walls is provided a coolant room 2h, which is charged with coolant K, preferably in a reverse direction flow, which extends also over the circumference and the entire axial length of the outlet pipe 2e up to the product outlet 2g (FIG. 1). When used with reverse direction flow, the coolant room 2h has a coolant entrance 2i on its lower end, charged with entering coolant k(E), which is preferably permeated by the product outlet 2g, and on its upper end a coolant exit 2k which discharges a leaving coolant flow K(A). At the upper side, the coolant room 2h ends in a flange 2l*, wherein the latter is connected to the surface of the residual, upwardly continuing infusion tank 2 in a detachable fashion, preferably by means of screw connections, and sealed by a first housing seal 3.12, preferably by way of an O-ring.

On its head end, the infusion tank 2 has a ring-shaped head flange 2m delimiting an upper tank opening 2s, which is connected to a head companion flange 2n (FIGS. 1, 2) in a detachable fashion, preferably by means of screw connections. The infusion head 3 is detachably fixed on the head companion flange 2n at the upper side thereof, preferably by screw connections, it consists of a product housing 3.1 neighbouring the head companion flange 2n (FIG. 2) and a subsequent steam housing 3.2.

The product housing 3.1 and the steam housing 3.2 are each penetrated by an inner housing body 3.3, preferably concentrically and movable in the direction of a longitudinal axis L of the infusion chamber 2a, 2b, 2c and sealed by way of a sixth housing seal 3.17. A preferably cylindrically designed middle body portion 3.3a and a preferably conical or bevelled lower body portion 3.3c of the inner housing body 3.3 tapering downward and from the outside towards the inside when seen in the radial direction, form together with the product housing 3.1 the ring-shaped product chamber 3.4. In its upper portion, the latter extends upward at first, along the middle body portion 3.3a, and subsequently downward, quasi in a meander form, wherein it is connected to the first product inlet 3.6 on its lower end. The middle body portion 3.3a and a preferably cylindrically designed upper body portion 3.3b of the inner housing body 3,3, which continues upward in an adjustment bar 3.10, form with the steam housing 3.2 a ring-shaped steam chamber 3.5 which is connected to the first stem inlet 3.7.1.

On its lower end, the steam chamber 3.5 is sealed at the inner side with respect to the middle body portion 3.3a by way of the sixth housing seal 3.17 in sliding engagement, and at the outer side with respect to the steam housing 3.2 by way of a seventh housing seal 3.18. On its upper end, the steam chamber 3.5 is sealed with respect to the adjustment bar 3.10 by way of a ninth housing seal 3.20 at the inner side, and at the outer side with respect to the steam housing 3.2 by way of an eight housing seal 3.19. On its upper end, the product chamber 3.4 is sealed with respect to middle body portion 3.3a by way of the already mentioned sixth housing seal 3.17 at the inner side, and at the outer side with respect to the product housing 3.1 by way of a fifth housing seal 3.16. The sixth housing seal 3.17 is received at the inner side between two not designated annular discs. At the outer side, the two discs are clamped in between the product- and the steam housing 3.1, 3.2, wherein the lower disc forms a sealing surface with respect to the fifth housing seal 3.16, and the upper disc forms a sealing surface with respect to the seventh housing seal 3.18.

The adjustment bar 3.10, connected preferably fixedly to the upper end of the inner housing body 3.3, extends in the longitudinal axis L, permeates the steam housing 3.2 upwardly and penetrates a lantern like designed holding- and guiding housing 3.11, in which it is guided at the respective end sides. Above the holding- and guiding housing 3.11, the adjustment bar 3.10 is connected to a not shown actuator drive, by way of which the inner housing body 3.3 can be displaced in the axial direction about an adjustment stroke H (see FIGS. 1, 2).

Radially on the interior, the inner housing body 3,3 accommodates a preferably centrally disposed second channel 3,3d in its lower and middle body portion and reaching into the upper body portion 3,3c, 3,3a, 3,3b (FIGS. 2,1), which has a connection to the ring-shaped steam chamber 3.5 surrounding it at the circumference side inside the steam housing 3.2 via plural admission openings 3,3f which are disposed so as to be distributed over the circumference of the inner housing body 3.3. On its lower end, the second channel 3.3d opens into the infusion chamber 2a, 2b, 2c via the lower body portion 3.3c in the centre of the upper area 2b, and preferably in the direction of the longitudinal axis L thereof.

The ring-shaped product chamber 3.4 inside the product housing 3.1 continues downwardly in a preferably annularly designed first channel 3.9, which encompasses the second channel 3.3d preferably concentrically and also opens into the infusion chamber 2a, 2b, 2c in the upper area 2b and from above. In the realisation example, the first channel 3.9 forms the food product to be heated P as a film flow F when it enters the upper area 2b (FIG. 1). However, a formation into fine droplets T can also take place at this location. Furthermore, the arrangement is made such that the first channel 3.9 has a first point of confluence E1 in the upper area 2b, and the second central channel 3.3d has a second point of confluence E2 in the upper area 2b, wherein the first point of confluence E1 is provided above the second point of confluence E2 (FIG. 2).

The ring-shaped first channel 3.9 has a variable passage cross section A at its first, droplet or film flow forming point of confluence E1 into the upper area, which can be continuously changed in the realisation example. This is achieved in that the passage cross section A has the form of an annular gap shaped cross section which is formed between a preferably nozzle-like designed bore 3.8a in the head companion flange 2n limiting the upper area 2b of the infusion chamber 2a, 2b, 2c, and the preferably conically designed lower body portion 3.3c penetrating the nozzle-shaped bore 3.8a. The nozzle-shaped bore 3.8a is preferably designed as a convergent nozzle and preferably in a separate nozzle plate 3.8, wherein the latter grips through the head companion flange 2n and is embedded in the same by way of the lower end of the infusion head 3, namely the product housing 3.1, in positive and non-positive fit (FIG. 2). The sealing of the nozzle plate 3.8 at the lower side with respect to the head companion flange 2n takes place via a third housing seal 3.14, and at the upper side with respect to the product housing 3.1 via a fourth housing seal 3.15. The head companion flange 2n is sealed with respect to the head flange 2m by means of a second housing seal 3.13.

The lower body portion 3.3c grips into the upper area 2b (FIG. 2), tapers thereto and in the penetration area with the nozzle plate 3.8 radially at the outer side, and forms the end side portion of the inner housing body 3.3, which is axially movable from the exterior of the infusion tank 2 in the longitudinal axis L thereof for the adjustment stroke H by way of the adjustment bar 3.10. The central second channel 3.3d widens out, preferably like a diffuser, at its exit point in the conical lower body portion 3.3c, namely such that its diffuser-like inner contour and the conical surface area of the lower body portion 3.3c form a bezel-like circumferential edge 3.3e at their ends.

The second steam inlet 3.7.2, which opens into the steam distribution chamber 2n.3 formed in the head companion flange 2n preferably via the two steam inlet necks 3.7.2a, 3.7.2b (FIG. 2) is connected for passing fluid to a plurality of inlet openings (2n.1, 2n.2), which are disposed in a ring shape and radially encompass the first channel 3.9 on the exterior and disembogue into the infusion chamber 2a, 2b, 2c in the upper area 2b and from above, and have a third point of confluence E3 for the second steam D2 there. In this, the third point of confluence E3 is preferably disposed approximately at equal height to the second point of confluence E2 for the first steam D1.

The inlet openings 2n.1, 2n.2 are preferably designed in the form of a first collar of inlet openings 2n.1 and of a second collar of inlet openings 2n.2, wherein the first collar of inlet openings 2n.1 radially, preferably concentrically, encompasses the second collar of inlet openings 2n.2 on the exterior. In this, the first and the second collar of inlet openings 2n.1, 2n.2 open out preferably directly into the wall area of the upper tank opening 2 which is preferably concentric to the longitudinal axis L, and the first collar of inlet openings 2n.1 is preferably oriented parallel to the longitudinal axis L and the second collar of inlet openings 2n.2 is preferably oriented downward and slanted towards the longitudinal axis L.

In the upper area 2b, there is a not shown and designated cleaning apparatus for automatic cleaning of all inner surface of the infusion chamber 2a, 2b, 2c with a cleaning agent, wherein the cleaning apparatus in the realisation example consists of a supply pipe penetrating through the upper bottom of the infusion tank 2 with a spray ball arranged at the end thereof. For sakes of visual inspection, in particular during the operation of the infusion system 1, the infusion tank 2 is provided with a number of inspection glasses 2o over its entire length of extension. Non-condensable gases escaping from the product P to be heated during the operation of the infusion system 1 are discharged into the surroundings via a gas outlet neck 2q arranged in the area of the infusion tank 2 (FIG. 1).

A second embodiment of the infusion system 1 (FIG. 1a) differs from the above described first embodiment according to FIG. 1 through a changed design of the lower area 2c and of the subsequent bottom 2d of the infusion tank 2, wherein additional installations for influencing the discharge of the heated food product P′ are provided in lower area 2c.

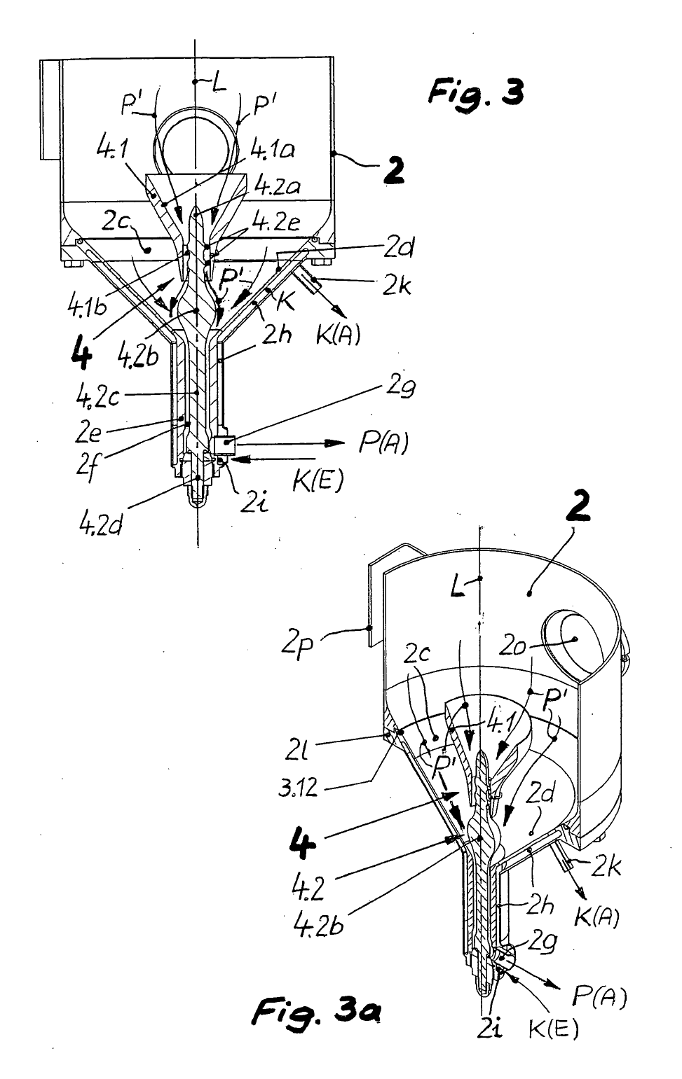

In the manner described already above, the outlet pipe 2e accommodating the outlet channel 2f follows up on the lower end of the preferably conically designed bottom 2d (FIG. 1a) and verges into the product outlet 2g at its lower end (FIGS. 1, 3, 3a). In contrast to the first embodiment according to FIG. 1, the conical bottom 2d ends in a bottom flange 2l at its upper side, wherein the latter is connected to the surface of the infusion tank 2 in a detachable manner, preferably by way of screw connections and being sealed by the first housing seal 3.12, preferably by way of an O-ring. The infusion system 1 is stationarily fixed via a tank holder 2p.

A capturing device 4 is provided in the lower area 2c of the infusion chamber 2a, 2b, 2c (FIGS. 3, 3a), which consists at least of a capturing funnel 4.1, whose conically downward tapering intake surface 4.1a opens out into a downward opened flume 4.1b. The flume 4.1b is in alignment with an outlet channel 2f arranged in the outlet pipe 2e.

The delivery resistances and -losses in the run-out area of the infusion chamber can be reduced or minimized, respectively, when vortexes and whirls are prevented in this area as far as possible. This is achieved by a drain-off pin 4.2, which is fastened at the lower end of the outlet pipe 2e by a fastening portion 4.2d for the sake of a loss-avoiding flow with sufficient distance to the outlet pipe 2e and which grips through the outlet channel 2f having a downstream flow portion 4.2c and through the flume 4.1b up to the interior of the conical intake surface 4.1a having an upward flow portion 4.2a. The upward flow portion 4.2a tapers sharply on its upper end. In the clearance between the lower end of the capturing funnel 4.1 and the upper end of the outlet channel 2f, the drain-off pin 4.2 has an enlargement part 4.2b, wherein the latter enlarges radially and is designed to be continuously bent on all sides. In its penetration area, the drain-off pin 4.2 is fixedly connected to the capturing funnel 4.1 via at least one fastening cross head 4.2e.

The product flow P(E) entering the infusion head 3 via the product inlet 3.6 on a path via the two product inlet necks 3.6a, 3.6b (FIGS. 2, 1), i.e. the food product to be heated P, arrives at the first point of confluence E1 via the ring-shaped product chamber 3.4 and the ring-shaped first channel 3.9 following up the former at the bottom side, and escapes via these as a ring-shaped stream in the form of a film flow F into the upper area 2b of the infusion chamber 2a, 3b, 2c, in order to fall down from there as a downward flow through the middle area 2a up to the lower area 2c which is limited by the conical bottom 2d at the bottom side. Concomitantly with the entering product flow P(E), the first steam D1 is supplied to the first steam inlet 3.7.1 and the second steam D2 to the second steam inlet 3.7.1. Via the ring-shaped steam chamber 3.5 and the admission openings 3.3f, the first steam D1 arrives in the central second channel 3.3d in order to leave from there via the second point of confluence E2 somewhat below the first point of confluence E1 into the lower area 2b and being at the inner side of the annular leaving stream of the food product P. The second steam D2 flows to the annular steam distribution chamber 2.n.3 via the two steam inlet necks 3.7.2a, 3.7.2b, in order to escape from there via the first and the second collar of inlet openings 2n.1, 2n.2 at the third point of confluence E3, also in the lower area 2b and now at the outside of the annularly escaping stream of the food product P.

In this, the first steam D1 leaving freely downward as a stream (FIG. 1) mixes with the ring-shaped stream of the food product P to be heated which encompasses it, such that the first steam D1 entrains the food product P to be heated in the axial direction and radially from the outside to the inside. The second steam D2, also leaving downward as a stream, encompasses the ring-shaped stream of the food product P. The latter is over the entire falling time, and thus over its entire time of residence in the infusion chamber 2a, 2b, 2c, in a direct heat exchange with the first and the second steam D1, D2, wherein the heat input at the inner side by the first steam D1 and the bundling and focussing effects accompanied by this prevail. Food product P, drifting off radially outward and thus being not affected by the first steam D1, is affected and heated by the second steam D2 and moreover, adhesion and scalding of this food product P on the surface of the infusion tank 2 is prevented to a high extent by the second steam D2.

By the controllable quantitative proportion between the first and the second steam D1, D2, the proportion of the heat inputs into the stream of the food product P is controllable between inside and outside in a wide range, and the bundling and focussing of the stream of food product P can also be achieved in the desired manner via this quantitative proportion D1/D2. The quantitative proportion D1/D2 can be changed very simply via a first pressure p(D1) of the first steam D1 and a second pressure p(D2) of the second steam D2 or via a differential pressure Δp, which results from the difference between the first pressure p(D1) and the second pressure p(D2), namely Δp=p(D1)−p(D2).

The film flow forming first point of confluence E1 of the ring-shaped first channel 3.9 into the upper area 2b can be continuously changed in its passage cross section A by an axial displacement of the inner housing body 3.3 by way of the adjustment bar 3.10, at maximum in the dimension of the adjustment stroke H. Here, an arrangement can also be made where fine droplets T are formed, whose magnitude can be changed either continuously or whose number can be changed in steps, for instance by partial admission of existing droplet forming passage cross sections.

The stream of food product P remains essentially centrally bundled and in the lower area 2c it arrives in the conical flowing-out hole 2d* (FIG. 1) as a heated food product P′, or predominantly in the capturing funnel 4.1 of the capturing device 4 (FIGS. 1a, 3, 3a). In the last mentioned realisation example, the food product P′ flows from here to the outlet channel 2f via the flume 4.1b, fluidically guided and assisted by the drain-off pin 4.2. Food product P′ flowing to the conical bottom 2d outside of the capturing funnel 4.1 arrives below the enlargement part 4.2b of the drain-off pin 4.2 also in the flume 2f, and there it is merged with the portions from the middle area.

The overall flow of the heated food product P′ leaves the product outlet 2g as a leaving product flow P(A) (FIGS. 1, 1a, 3, 3a), and from there it is fed to the downstream process plant for further treatment. The conical bottom 2d, as well as the outlet pipe 2e which follows at the downside is cooled by the coolant room 2h, preferably in reverse flow, wherein the entering coolant flow K(E) is fed to the coolant entrance 2i, and the leaving coolant flow K(A) is discharged via the coolant exit 2k.

This completes the description of the preferred and alternate embodiments of the invention. Those skilled in the art may recognize other equivalents to the specific embodiment described herein which equivalents are intended to be encompassed by the claims attached hereto.

### LIST OF REFERENCE SIGNS OF THE USED ABBREVIATIONS

1 infusion system
2 infusion tank
2a, 2b, 2c infusion chamber
2a middle area
2b upper area
2c lower area
2d bottom (tapering downward)
2d* conical flowing-out hole
2e outlet pipe
2f outlet channel
2g product outlet (for the heated food product P′)
2h coolant room
2i coolant entrance
2k coolant exit
2l bottom flange
2l* flange
2m head flange
2n head companion flange
2n.1 first collar of entrance openings
2n.2 second collar of entrance openings
2n.3 (annular) steam distribution chamber
2o inspection glass
2p tank mounting
2q gas outlet neck
2s upper tank opening
3 infusion head
3.1 product housing
3.2 steam housing
3.3 inner housing body
3.3a (cylindrical) middle body portion
3.3b (cylindrical) upper body portion
3.3c lower body part (tapering downward at the exterior)
3.3d (central) second channel
3.3e bezel-like circumferential edge
3.3f admission opening
3.4 annular product chamber
3.5 annular steam chamber
3.6 product inlet
3.6.a first product inlet neck (for the food product to be heated P)
3.6b second product inlet neck (for the food product to be heated P)
3.7.1 first steam inlet (for steam D1)
3.7.2 second steam inlet (for steam D2)
3.7.2a first steam inlet neck (for steam D2)
3.7.2b second steam inlet neck (for steam D2)
3.8 nozzle plate
3.8a (nozzle-shaped) bore
3.9 (annular) first channel
3.10 adjustment bar
3.11 holding- and guiding housing
3.12 first housing seal
3.13 second housing seal
3.14 third housing seal
3.15 fourth housing seal
3.16 fifth housing seal
3.17 sixth housing seal
3.18 seventh housing seal
3.19 eighth housing seal
3.20 ninth housing seal
4 capturing device
4.1 capturing funnel
4.1a (conical) intake surface
4.1b flume
4.2 drain-off pin
4.2a upward flow portion
4.2b enlargement part
4.2c downward flow portion
4.2d fastening portion
4.2e fastening crosshead
A passage cross section
D1 first steam (water steam, preferably as hot steam)
D2 second steam (water steam, preferably as hot steam)
E1 first point of confluence
E2 second point of confluence
E3 third point of confluence
F film flow
G not condensable gases
H adjustment stroke
K coolant
K(E) entering coolant flow
K(A) leaving coolant flow
L longitudinal axis (of the infusion chamber or the infusion tank, respectively)
P food product to be heated
P′ heated food product
P(A) leaving product flow
P(E) entering product flow
T droplets
p(D1) first pressure (of the first steam D1)
p(D2) second pressure (of the second steam D2)
Δp differential pressure (Δp=p(D1)−p(D2)

1. Infusion system (1) for a liquid food product (P) to be heated, including an infusion chamber (2a, 2b, 2c) limited by an infusion tank (2) with a downward tapering bottom (2d), said infusion chamber (2a, 2b, 2c) having a product inlet (3.6) for the food product to be heated (P) in its upper area (2b) and a product outlet (2g) for the heated food product (P′) in its lower area (2c), said infusion system (1) having a steam inlet for the steam heating medium in the upper area (2b), wherein
the steam inlet is designed in the form of two steam inlets (3.7.1, 3.7.2) separated from each other spatially and fluidically;
the first steam inlet (3.7.1) is connected for passing fluid to a second channel (3.3d) and the second channel (3.3d) opens into the infusion chamber (2a, 2b, 2c) in the centre of the upper area (2b),
the product inlet (3.6; 3.6a,3.6b) is connected for passing fluid to a first channel (3.9) which encompasses the second channel (3.3d) in a ring shape and also opens into the infusion chamber (2a, 2b, 2c) in the upper area (2b) and from above,
and the second steam inlet (3.7.2; 3.7.2a, 3.7.2b) is connected for passing fluid to a plurality of inlet openings (2n.1, 2n.2) disposed in a ring shape and radially encompassing the first channel (3.9) on the exterior and also opening into the infusion chamber (2a, 2b, 2c) in the upper area (2b) and from above.

2. Infusion system according to claim 1, wherein
the inlet openings (2n.1, 2n.2) are designed in the form of a first collar of inlet openings (2n.1) and of a second collar of inlet openings (2n.2), and that the first collar of inlet openings (2n.1) radially encompasses the second collar of inlet openings (2n.2) on the exterior.

3. Infusion system according to claim 2, wherein
the first and the second collar of inlet openings (2n.1, 2n.2) open out directly into the wall area of an upper tank opening (2s) via which the upper area (2b) opens in the upward direction towards the first channel (3.9) and the second channel (3.3d).

4. Infusion system according to claim 2, wherein
the first collar of inlet openings (2n.1) is oriented parallel to the longitudinal axis (L) and the second collar of inlet openings (2n.2) is oriented downward and slanted towards the longitudinal axis (L).

5. Infusions system according to claim 1 wherein
the first channel (3.9) has a first point of confluence (E1) in the upper area (2b), the second channel (3.3d) has a second point of confluence (E2) in the upper area (2b), and the inlet openings (2n.1, 2n.2) have a third point of confluence (E3), that the second and the third point of confluence (E2, E3) are disposed approximately on the same height, and that the first point of confluence (E1) is provided above the second point of confluence (E2).

6. Infusion system according to wherein
the first channel (3.9) has a variable passage cross section (A) at its first point of confluence (E1).

7. Infusion system according to claim 6, wherein
the passage cross section (A) can be changed continuously or in steps.

8. Infusion system according to claim 6, wherein
the passage cross section (A) has the form of an annular gap shaped cross section which is formed between a bore (3.8a) in a head companion flange (2n) limiting the upper area (2b) of the infusion chamber (2a, 2b, 2c), and a lower body portion (3.3c) penetrating the bore (3.8a), wherein the former grips into the upper area (2b), radially tapers thereto at the exterior and forms an end side portion of an inner housing body (3.3), which is axially movable from the exterior of the infusion tank (2) in the longitudinal axis (L) thereof.

9. Infusion system according to claim 7, wherein
the bore (3.8a) is designed as a convergent nozzle.

10. Infusion system according to claim 8, wherein
the inner housing body (3.3) receives the second channel (3.3d) radially at the interior, which has a connection to the circumferential surroundings of the inner housing body (3.3) via plural admission openings (3.3f) arranged such as to be distributed over the circumference of the inner housing body (3.3).

11. Infusion system according to claim 10, wherein
the second channel (3.3d) widens out like a diffuser at its exit point in the lower body portion (3.3c), and that the diffuser-like inner contour and a downward tapering surface area of the lower body portion (3.3c) form a bezel-like circumferential edge (3.3e) at their ends.

12. Infusion system according to claim 8 wherein
an infusion head (3) arranged on the head companion flange (2n) at the upper side is provided, which consists of a product housing (3.1) neighbouring the head companion flange (2n) and of a steam housing (3.2) following up the former, that the product housing (3.1) and the steam housing (3.2) are sealingly penetrated by the inner housing body (3.3) which is movable in the direction of the longitudinal axis (L), that a middle and the lower body portion (3.3a, 3.3c) of the inner housing body (3.3) form with the product housing (3.1) a ring-shaped product chamber (3.4) having the product inlet (3.6; 3.6a, 3.6b), and the middle (3a) and an upper body portion (3.3) as well as an adjustment bar (3.10), following up the latter, of the inner housing body (3.3) form with the steam housing (3.2) a ring-shaped steam chamber (3.5) having the first steam inlet (3.7.1).

13. Infusion system according to claim 1 wherein
a capturing device (4) is provided in the lower area (2c) of the infusion chamber (2a, 2b, 2c), that the former consists at least of a capturing funnel (4.1), whose conically downward tapering intake surface (4.1a) runs out into a downward opened flume (4.1b), and that the flume (4.1) is in alignment with an outlet channel (2f) arranged in an outlet pipe (2e), wherein the outlet pipe (2e) follows up the bottom (2d) at its upper end, and verges into the product outlet (2g) at its lower end.

14. Infusion system according to claim 1, wherein
at least the bottom (2d) is designed double-walled and a coolant room (2h) charged with coolant (K) is provided between the two walls.

15. Infusion system according to claim 14, wherein
the lower portion of the middle area (2a) is designed double-walled in addition, and the coolant room (2h) continues between the two walls.

16. Infusion system according to claim 14, wherein
the coolant room (2h) extends also over the circumference and the entire axial length of the outlet pipe (2e) up to the product outlet (2g).

17. Method for directly heating a liquid food product (P) in an infusion system (1) with an infusion chamber (2a, 2b, 2c), to which the food product (P) to be heated is supplied in the upper area (2b), and from which the heated food product (P′) is discharged in the lower area (2c), wherein the food product (P) to be heated entering finely divided the infusion chamber (2a, 2b, 2c) permeates the infusion chamber (2a, 2b, 2c) as a downward flow, wherein steam is supplied to the upper area (2b) and wherein during the entire residence time of the food product (P) to be heated in the infusion chamber (2a, 2b, 2c), the former is in a heat exchange with the steam, wherein
a first steam (D1) is supplied to the upper area (2b) centrally from top to bottom as an inner free stream,
the food product (P) to be heated is supplied to the upper area (2b) from top to bottom as a ring-shaped middle free stream encompassing the inner free stream of the first steam (D1),
and a second steam (D2) is supplied to the upper area (2b) from top to bottom as a ring-shaped outer free stream which encompasses the middle free stream.

18. Method according to claim 17, wherein
the food product (P) to be heated is formed in fine droplets (T) when it enters the upper area (2b).

19. Method according to claim 17, wherein
the food product (P) to be heated is formed as a film flow when it enters the upper area (2b).

20. Method according to claim 17, wherein
the heat input into the food product (P) to be heated is controlled via the quantitative proportion between the first and the second steam (D1, D2).

21. Method according to claim 17, wherein
the food product (P) to be heated is a dairy product.

22. Method according to claim 21, wherein
the dairy product is milk, cream or yogurt.

23. Utilisation of an infusion system (1) according to claim 1 in a process plant for the production of a dairy product.

24. Utilisation of an infusion system (1) according to claim 23, wherein
the dairy product is UHT milk or ESL milk, that the food product (P) to be heated, the milk to be heated, is withdrawn form the process plant, is fed into the infusion system (1) for milk heating, and that the heated food product (P′), the heated milk, is subsequently processed further in the process plant.

25. Utilisation of an infusion system (1) according to claim 24, wherein
the dairy product is cream or yogurt.
